(19) United States
(12) Patent Application Publication
(10) Pub. No.: US 2025/0289232 A1
(43) Pub. Date: Sep. 18, 2025

(54) ARRANGEMENT FOR GUIDING INK TO ONE OR MORE PRINTHEADS OF AN INK JET PRINTING SYSTEM

(71) Applicant: CANON KABUSHIKI KAISHA, Tokyo (JP)

(72) Inventors: Florian HITZLSPERGER, Poing (DE); Christoph RUMMELSBERGER, Ismaning (DE); Ulrich STOCKLE, Germering (DE); Jan A. VAN DER BOS, Beuningen (NL); Jeroen COX, Roermond (NL)

(21) Appl. No.: 19/075,535

(22) Filed: Mar. 10, 2025

(30) Foreign Application Priority Data
Mar. 12, 2024 (DE) 10 2024 000 817.9

(51) Int. Cl. B41J 2/175; B41J 2/18; B41J 2/19

(52) U.S. Cl. CPC B41J 2/17556; B41J 2/17523; B41J 2/17563; B41J 2/17596; B41J 2/18; B41J 2/19

(57) ABSTRACT

An arrangement for directing ink to print heads of an ink jet printing system. The arrangement including print heads, an ink distributor device, a proportional valve, a buffer tank, and a control unit. The ink distributor device is configured to distribute ink to the print heads. Pressure sensors measure pressure within the ink distribution device and send the measured pressure to the control unit. The control unit controls the proportional valve based on the measured pressure in the ink distribution device and to control an ink flow into the ink distribution device. The buffer tank belongs to a closed system and can be filled in part with ink and in part with a gas, in particular air. A pressure regulator controls a gas pressure in the buffer tank, the buffer tank being ink-connected to the proportional valve and providing the ink to the ink distributor device.

### CROSS-REFERENCE TO RELATED APPLICATIONS

This application claims priority to German Patent Application No. 10 2024 000 817.9 filed on Mar. 12, 2024, which is incorporated by reference in its entirety.

### BACKGROUND OF THE DISCLOSURE

### Field of the Disclosure

The disclosure relates to an arrangement for guiding ink to one or more print heads of an ink jet printing system.

### Description of the Related Art

Ink printing devices can be used for printing on a printing material or recording medium. Such systems for ink jet printing operate, for example, according to the drop-on-demand principle. These have one or more print heads including nozzle units having ink channels and activators. The activators, controlled by a printer control, can excite ink drops in the direction of the recording medium, which are directed onto the recording medium in order to apply printing dots for a printed image there. The activators can generate ink drops thermally or piezoelectrically. When ink is supplied and/or discharged to one or more printheads or away from one or more printheads of an ink jet printing system, a great challenge is to design the ink supply in such a way that sufficient ink arrives in each printhead with a correct pressure and a correct flow rate. The printheads must be supplied with ink continuously. A pressure in a distribution system designed to distribute ink to one or more printheads should be kept stable and should not fluctuate above a certain threshold, usually less than 10 mBar. Both ink shortages and overfill events can cause nozzle failures.

The ink can be filled into a back-pressure tank that adjusts the pressure hydrostatically by the ink level in relation to the print head surface. This tank can be refilled and controlled by a pump. However, a pump can exert a shear load on the ink and lead to agglomeration or a change in the ink and its properties.

US 2022/0371327 A1 discloses that ink is located in a closed pressure tank that is partially filled with air and partially filled with ink, while a pressure is set by controlling the air pressure. A complex fluctuation limiting device is also provided here.

### SUMMARY OF THE DISCLOSURE

A simplified solution is sought for the task of the disclosure.

An arrangement is proposed.

The disclosure relates to an arrangement for directing ink to one or more print heads of an ink jet printing system. The arrangement has one or more print heads. For this purpose, at least one ink distributor device, a proportional valve, a buffer tank and a control unit are provided.

The ink distribution device is configured to distribute ink to one or more print heads. One or more pressure sensors that are set up to measure a pressure within an ink distribution device and to send it to the control unit.

The control unit is configured to control the proportional valve based on the measured pressure in the ink distribution device and to control an ink pressure flow into the ink distribution device.

The buffer tank is part of a closed system and can be filled partly with a gas, in particular air, and partly with ink. The closed system has a pressure regulator configured to control a gas pressure in the buffer tank. The buffer tank is ink-connected to the proportional valve and provides the ink for the ink distribution device.

The advantage of the disclosure is that the exact pressure level at an inlet of the print heads, namely the ink distribution device, is measured and maintained directly, so that the pressure level is correct independently of the ink pressure flow quantity. Furthermore, the ink is transported to the print heads not with a pump but by a gas pressure, as a result of which less shear stress is exerted on the ink.

Preferably, the proportional valve is located closer to the ink distribution device than to the buffer tank. By this spatial closeness to the ink distribution device, a faster reaction to a change of gas pressure is possible.

The arrangement preferably further includes an ink-merging device configured to merge a flow from the one or more print heads, the ink-merging device having one or more pressure sensors configured to measure a pressure in the ink-merging device and to send the measured pressure to the control unit. This is advantageous since the print heads can be flushed in this way.

In particular, the arrangement also has a discharge pump, the control unit being set up to control the discharge pump in such a way that a measured pressure in the ink-merging device remains constant. The control unit is even more preferably set up to adjust a constant flow through the one or more print heads by setting a constant pressure gradient between a measured pressure in the ink distribution device and a measured pressure in the ink merging device. In this way, the ink flow can advantageously be set very precisely and hardly prone to errors. In particular, the pressure in the ink-merging device is controlled negatively with respect to atmospheric pressure.

In a particularly advantageous embodiment, the control unit is designed as an FPGA (field programmable gate array). This is particularly inexpensive and easy to handle. Alternatively, a control unit can also be a central operating unit.

The arrangement preferably has a T-junction downstream of the discharge pump, a first outlet of the T-junction preferably being provided with a return valve that is configured to open or close a return flow into the buffer tank, a second outlet being provided with a drain valve which opens or closes a drain of ink. This is advantageous because in this way, depending on the filling volume in the buffer tank and depending on the degree of clumping, the ink flowing through the print heads can be used further or can also be disposed of.

In particular, the arrangement between buffer tank and proportional valve has at least one filter for filtering out clumps. This is advantageous since in this way the service life of the ink heads is increased by ensuring good ink consistency.

In a particularly advantageous embodiment, the arrangement is arranged between the buffer tank and proportional valve with at least one degasser.

The arrangement between buffer tank and proportional valve preferably has at least one heat exchanger. This is advantageous since an ink temperature can be controlled in this way. For this purpose, the arrangement even more preferably has at least one temperature sensor between the buffer tank and the proportional valve.

The ink distribution device and/or the ink merging device preferably each have a volume that can be filled partly with ink and partly with air or another gas, an ink filling level and a gas pressure being adjustable. The ink distribution device and/or the ink merging device is/are connected at a second horizontal end to an end piece.

In particular, a volume of the ink distribution device and/or of the ink merging device is designed in such a way that pressure waves that continue from the print head to the ink guide device are cushioned. This is advantageous since in this way a function of a back-pressure tank is assumed by the ink distribution device and/or the ink merging device.

Preferably, the ink distribution device and/or the ink merging device has a parallelepiped shape, a horizontal width extension being in particular smaller than a vertical extension. This is advantageous since this is a particularly simple form in order to fulfill all the specifications mentioned so far.

In particular, the ink distribution device and/or the ink-merging device has a volume of between 500 ml and 3.5 L. The volume is preferably set up to be filled with ink between 30 and 70% and to be filled with gas, in particular air, up to 30 to 70%. In this way, the condition that pressure waves that continue from the print head to the ink guide device are cushioned is particularly preferably fulfilled.

A cross-section of the ink distribution device and/or of the ink merging device is in particular between 15 and 35 mm wide and between 60 and 100 mm high.

In an embodiment, the ink distribution device and/or the ink merging device is made of plastic. This is particularly inexpensive and easy to produce. However, it is also conceivable for the ink distribution device and/or the ink-merging device to be made of metal, in particular stainless steel.

In particular, the ink distribution device and/or the ink merging device has one or more sensors for determining an ink level, in particular a capacitive level sensor. This is advantageous since simple control is made possible in this way.

In an advantageous embodiment, the ink distributor device and/or the ink merging device has one or more sensors for determining a gas pressure. This is advantageous since a simple control is also made possible with this.

In particular, a filling level height is set to a certain value in a starting phase of a control so that a ratio between air and ink in the ink distribution device and/or the ink merging device is correct. Furthermore, the filling level height is preferably measured so that there is no idling or overfilling of the ink distribution device and/or the ink merging device.

Preferably, the ink distribution device has a horizontal connecting piece that is connected in ink-guiding manner to the proportional valve that controls a passage ink velocity as a function of the gas pressure. This is advantageous since a good ink supply is provided in this way. At a constant ink flow rate through the print heads, a fixed opening value is thus established at the proportional valve. When the printheads start printing, more ink is needed. The pressure in the ink distribution device decreases in this case. This is then compensated by the proportional valve by opening it further.

The control unit is preferably set up to carry out the setting of the filling level in the starting phase during each maintenance operation, which is the case in an embodiment approximately after between 1.5 and 3.5 hours in each case.

### BRIEF DESCRIPTION OF THE DRAWINGS

Further advantages and embodiments of the present disclosure are apparent from the drawing and the following description of the figures.

FIG. 1 shows a schematic flow chart representation of an embodiment of an arrangement according to the disclosure, which is designated here by 100.

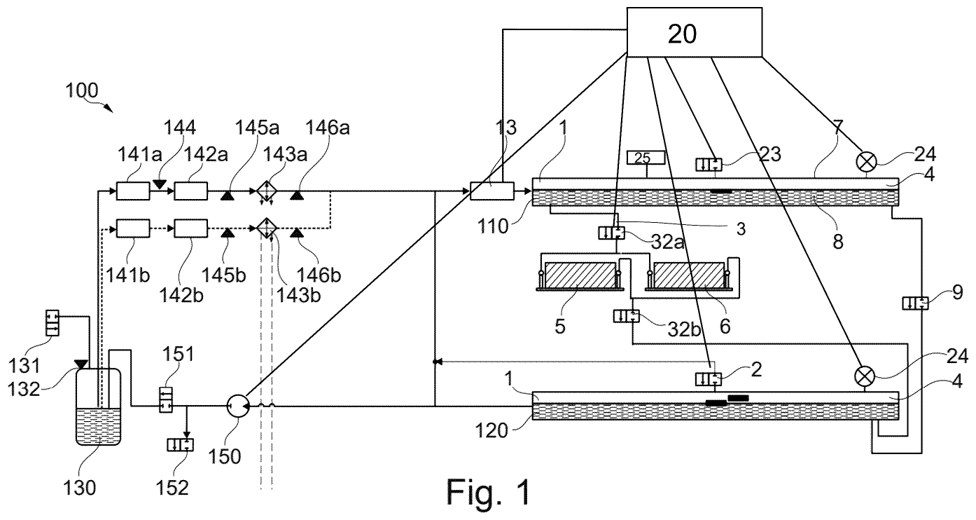

### DESCRIPTION OF THE EMBODIMENTS

The arrangement 100 has two print heads 5, 6. The arrangement 100 has an ink distribution device 110, an ink merging device 120, a proportional valve 13, a buffer tank 130, and a control unit 20

The ink distribution device 110 is arranged to conduct ink to the two print heads 5, 6. The ink-merging device 120 is arranged to discharge ink from the two print heads 5, 6. The ink distribution device 110 and the ink merging device 120 are each partially filled with ink 8 at their lower end and partially filled with gas 7 at their upper end. The ink distribution device 110 and the ink merging device 120 each have capacitive pressure sensors 23 and a filling level sensor 24. By means of a line proportional valve 13, an ink supply to a front end 1 of the ink distribution device 110 is controlled by the control unit as a function of a measured pressure in the ink distribution device 110 23. The filling level sensor 24 and the pressure sensors 23 send their measurement data to the control unit.

A lower connecting piece 3 is provided on the ink distribution device 110, which connects the ink distribution device 110 below to the two print heads 5, 6 in ink-guiding manner. The connecting piece 3 has a connecting valve 32a that controls an ink flow to the two print heads 5, 6.

The ink-merging device 120 is arranged to discharge ink from the two print heads 5, 6. In addition, a further valve 9 is provided between the ink distribution device 110 and the ink-merging device 120. The valve 9 permits a flow of ink from the ink distribution device 110 directly to the ink-merging device 120. In this way, a certain flow can advantageously be generated and maintained independently of a printing process, so that the ink does not lose its quality by being stationary.

The further valve 9 is arranged here between an end piece 4 of the ink distribution device 110 and an end piece 4 of the ink-merging device 120. In this way, a flow direction of ink in the ink-merging device 120 is exactly opposite to a flow direction of ink in the ink distribution device 110.

A lower connecting piece 3 is also provided on the ink-merging device 120, which connects the ink-merging device 120 underneath to the two print heads 5, 6 in ink-guiding manner. The connecting piece 3 has a connecting valve 32b that controls an ink flow from the two print heads 5, 6.

The buffer tank 130 is part of a closed system. It may partly be filled with a gas, in particular air, and particularly can be filled with ink. The closed system has a pressure regulator 25 that is arranged to control a gas pressure in the buffer tank 130. The buffer tank 130 is ink-connected to the proportional valve 13 and provides the ink for the ink distribution device 110. The buffer tank 130 has a fill level sensor 132, with which an ink fill level of the buffer tank 130 can be measured. The control unit is set up to control a supply line of ink to the buffer tank 130 by means of a supply valve 131.

The arrangement 100 also has a discharge pump 150, the control unit being arranged to control the discharge pump 150 in such a way that a measured pressure in the ink-merging device 120 remains constant.

Subsequent to the discharge pump 150, the arrangement 100 has a T-junction in this embodiment. A first outlet of the T-junction is provided with a return valve 151 that is arranged to open or close a return flow of ink into the buffer tank 130. A second outlet of the T-junction is provided with a drain valve 152 that opens or closes a drain of ink.

Between the buffer tank 130 and the proportional valve 13, in this embodiment, a first filter 141a, a second filter 141b, a first degasser 142a, a second degasser 142b, a further pressure sensor 144, a first heat exchanger 143a, a second heat exchanger 143b, a first temperature sensor 145a, a second temperature sensor 145b, a third temperature sensor 146a and a fourth temperature sensor 146b are provided.

Embodiments can be implemented as hardware (e.g. circuits, firmware, software or any combination thereof). Embodiments can also be implemented as instructions which are stored on a machine-readable medium which can be read and executed by one or more processors. A machine-readable medium can have any mechanism for storing and transmitting information which can be read by a machine (e.g. a computer). For the purposes of this discussion, the expression control unit should be understood as circuits or processor or combinations thereof including memory instructions. A circuit comprises an analog circuit, a digital circuit, a data processing circuit, other structural electronic hardware or a combination thereof. A processor comprises a microprocessor, a digital signal processor (DSP), a central processor (CPU), a processor (ASIP) set by application-specific instructions, a graphics and/or image processor, a multi-core processor or another hardware processor.

1. An arrangement for directing ink to one or more printheads of an ink jet printing system, the arrangement comprising:
one or more printheads;
at least one ink distribution device;
a proportional valve;
a buffer tank;
a control unit,
wherein the at least one ink distribution device being adapted to distribute ink to the one or more printheads; and
one or more pressure sensors configured to measure a pressure within the ink distribution device and to send the measured pressure to the control unit,
wherein the control unit is configured to control the proportional valve based on the measured pressure in the ink distribution device and to control an ink flow into the ink distribution device,
wherein the buffer tank belonging to a closed system and being fillable in part with ink and in part with a gas, in particular air, and
wherein the closed system includes a pressure regulator configured to control a gas pressure in the buffer tank, the buffer tank being ink-connected to the proportional valve and providing the ink to the ink distribution device.

2. The arrangement according to claim 1, wherein the proportional valve is located closer to the ink distribution device than to the buffer tank.

3. The arrangement according to claim 1, further comprising an ink merging device configured to merge a flow from the one or more printheads, wherein the ink merging device including one or more pressure sensors configured to measure pressure in the ink merging device and to send the measured pressure to the control unit.

4. The arrangement according to claim 3, further comprising a discharge pump, wherein the control unit controls the discharge pump so that a measured pressure in the ink merging device remains constant.

5. The arrangement according to claim 4, wherein the constant pressure to which the discharge pump is controllable is an underpressure with respect to atmospheric pressure.

6. The arrangement according to claim 4, wherein the control unit is configured to adjust a constant flow through the one or more print heads by setting a constant pressure gradient between a measured pressure in the ink distribution device and a measured pressure in the ink merging device.

7. The arrangement according to claim 1, wherein the control unit is formed as an FPGA (field programmable gate array).

8. The arrangement according to claim 1, further comprising a T-junction downstream of the discharge pump,
wherein the T-junction includes a first outlet having a return valve configured to open or close a return flow into the buffer tank, and
wherein the T-junction includes a second outlet having a discharge valve configured to open or close a discharge of ink.

9. The arrangement according to claim 1, further comprising at least one filter configured to filter out clumps between the buffer tank and the proportional valve.

10. The arrangement according to claim 1, further comprising at least one degasser provided between the buffer tank and the proportional valve.

11. The arrangement according to claim 1, further comprising at least one heat exchanger between the buffer tank and the proportional valve.

12. The arrangement according to claim 1, further comprising at least one temperature sensor between the buffer tank and the proportional valve.
